(19) United States
(12) Patent Application Publication
(10) Pub. No.: US 2015/0082778 A1
(43) Pub. Date: Mar. 26, 2015

(54) Balanced actuating device for lifting and/or transport apparatus and apparatus comprising the device

(71) Applicant: Giuseppe BARONE, Termini Imerese (PA) (IT)

(72) Inventor: Giuseppe Barone, Termini Imerese (PA) (IT)

(21) Appl. No.: 14/397,710

(22) PCT Filed: May 3, 2013
(86) PCT No.: PCT/IB2013/053532

§ 371 Date: Oct. 29, 2014

(30) Foreign Application Priority Data
May 3, 2012 (IT) PA2012A000010

(51) Int. Cl. F15B 15/22

(52) U.S. Cl. CPC F15B 15/22
USPC 60/326

(57) ABSTRACT

A balanced actuating device includes a supporting frame having a support for a load, a guide guiding the support along a drive direction, and a drive moving the support along the guide for a predetermined stroke between a first and a second end position. The drive includes a cylindrical jacket enclosing a first working chamber and housing a drive cylinder exerting a drive force on the support, a compensation cylinder placed externally to the drive cylinder and exerting thereon a compensation force sufficient to balance the external load, and a first supply station of the first chamber (8) with a pressurized fluid exerting one of the forces. The first supply station includes a reservoir containing two different fluids immiscible with each other, a first fluid being supplied into the first working chamber, a second fluid transmitting to the drive cylinder, through the first fluid, the compensation force.

### TECHNICAL FIELD

The present invention is generally applicable to the technical field of the systems for lifting and the transporting loads and/or persons and particularly relates to a balanced actuating device for lifting and/or transport apparatuses. The invention also relates to a lifting and/or transport apparatus incorporating the above device.

### STATE OF THE ART

Lifting and/or transport apparatuses, such as lifting platforms, forklifts, loaders, elevators and the like, are known which are designed to carry and/or vertically position persons and/or materials to a predetermined height relative to the ground or to a starting level.

Similar apparatuses operate with well known conventional actuating devices, such as hydraulic, oleodinamics or mechanical systems, for example rack systems or pulley.

These systems, however, are affected by several drawbacks, one of which is to require high power during both raising and lowering, involving a suitable dimensioning of the power supply means, with increase of both the overall dimensions and the power consumption.

From the European patent EP2152623 in the name of the same applicant, a balanced actuating device is known which is applicable to any type of lifting and/or transport apparatuses and which overcome in a substantially complete manner the above drawbacks.

The device operates with the simultaneous action of traditional drive means operating on suitable means for supporting the load and of a suitably preloaded elastic actuator element interacting with the above drive means for moving the load between a lower end position and an upper end position.

In particular, the preloaded elastic actuator element is sized to exert a compensation force on the supporting means sufficient to at least partially compensate the load and keep it in an intermediate position between the two end positions.

By this way, in the whole cycle of raising and lowering it will be possible to reduce the supplied powers, allowing the minimization of the size of the drive means.

However, this device has proved to be further improved, in particular as regards the overall dimensions of the drive means.

Indeed, the latter are separated with respect to the elastic element and as a consequence, in case of application of the actuator device to a lifting apparatus of already existing plants and/or machines, a problem may arise because the available spaces reduce the possibility of installation of the device.

From WO2005/061361 an apparatus for lifting loads is known which is provided with a load balanced actuating device that comprises a lifting hollow piston slidable inside a cylinder, coaxially thereto, to define two variable volume chambers for housing respective pressurized fluids.

In particular, the inner piston, connected to the support means of the load to be raised/lowered, is supplied with a mineral oil under pressure so that it can be raised and lowered.

The outer chamber is in turn supplied with a compensation fluid, oil or gas, so as to provide an additional force to the piston during the raising, while during the lowering the compensation fluid will serve to dampen the fall of the load.

The two variable-volume chambers are isolated with each other by gaskets arranged both at the lower end of the piston and at the upper one.

However, as also recognized by the same applicant of the above cited international application, the gaskets represent a critical point of the above load balanced actuating device.

To overcome this drawback, the same applicant has realized an improved drive device, disclosed in WO2008068492, in which a vent system is interposed between the two chambers for drawing any fluid leakage so as to expel them to the outside before the leaked fluid flew into the other chamber.

This solution, while solving the problem of fluid leakage from the cylinder to the piston, or vice versa, is overly complicated and therefore more expensive, and with lower reliability as a whole due to the increased number of components.

WO2006134324 discloses an improved drive device similar to those described above and in which a balancing reservoir is provided containing two fluids mutually separated by a membrane, so resulting particularly expensive and unreliable due to the delay in the elastic response caused by the presence of the membrane.

### DISCLOSURE OF THE INVENTION

Object of the invention is to overcome the above drawbacks, providing an improved balanced actuating device for lifting and/or transportation apparatuses such as lift, hoists, lifting platforms and the like which has high efficiency and relative cost-effectiveness.

A particular object is to provide an improved balanced actuating device for lifting and/or transport apparatuses which has high gas tightness, so as to ensure its autonomous operation for a relatively high number of cycles.

Yet another particular object is to provide an improved balanced actuating device for lifting and/or transport apparatuses using two working fluids, one of which being a driving fluid and the other a compensation fluid, contained in separate working chambers isolated from each other by hermetic sealing means having greater sealing properties compared with known solutions, in order to avoid the use of systems for drawing and expelling the leaked fluids, simplifying the whole structure of the device, improving the overall reliability and simplifying maintenance.

Another object is to provide an improved balanced actuating device for lifting and/or transport apparatus which has lower encumbrance with the same efficiency, being able to be easily installed also in already existing apparatuses.

These objects, as well as others that will become more apparent hereinafter, are fulfilled by a balanced actuating device, according claim 1, comprising a supporting frame having support means for an external load, guide means associated with said frame for guiding said support means along a predetermined direction, drive means acting on said support means for moving them along said guide means for a predetermined stroke between a first and a second end position, wherein said drive means comprise a cylindrical jacket defining a first working chamber and housing thereinside a drive cylinder adapted to exert a driving force on said support means, a compensation cylinder arranged externally to said drive cylinder and adapted to exert a compensation force thereon sufficient to at least partially balance the external load, means for supplying in said first chamber at least one pressurized fluid adapted to exert at least part of one of said forces.

The device is characterized in that said supply means comprise a reservoir containing predetermined amounts of two different fluids mutually immiscible having respective menisci in mutual contact, a first of said fluids being able to be supplied in said first working chamber, the other of said fluid being adapted to transmit on said supporting means, through said first fluid, at least part of said compensation force.

This combination of features will allow to greatly simplify the structure of the device, in particular when a gas is used as compensation fluid.

The direct contact between the two fluids will avoid the provision of the membrane, reducing the overall costs, and obtaining a more effective and immediate transmission of the force between the two fluids.

Moreover, it will not be necessary to prepare any special seal for gas-tight, as this fluid inside the tank will be properly stopped from the other fluid, preferably an oil and will never act against seals also working towards the atmosphere, i.e. against a pressure which is normally lower than the pressure of the fluid and that therefore would be more strongly subject to leakage, also because of the smaller size of the molecule of gas compared to that of oil that would favor the passage through the seal.

Suitably, said supplying means may comprise a first drawing conduit adapted to draw said first fluid from said reservoir and to supply it into said first chamber.

Thanks to this further combination of features, if the compensation fluid was a gas, it can take advantage of the damping effect produced by the same gas directly on the oil, while eliminating the problems of leakage as the gas will be retained in the reservoir by the oil.

Advantageously, the drive cylinder and the compensating cylinder may be at least partially housed in a same containment jacket to operate on the same pushing element, so as to obtain a considerable reduction of the overall dimensions of the device, which may be easily inserted even in existing lifting apparatuses.

Suitably, the first and the second variable volume chamber will be fluidically isolated from each other by hermetic sealing means and connected respectively to first and second supplying means of the respective fluid with the interposition of corresponding first and second valve means.

Advantageously, said sealing means may comprise a sealing element having a first sealing section operating toward said first chamber and a second sealing section operating toward said second chamber, said sections being adapted to support respective fluid pressures differentiated with each other.

Thanks to this particular embodiment, the device according to the invention will solve the fluidic sealing drawbacks of the known solutions maintaining a constructively simple structure and therefore more cost-efficient, reliable and easier to maintain.

According to another variant, the reservoir may be integrated inside said jacket to define said compensation cylinder, one of the fluids contained in said reservoir being a mineral oil or the like housed in a lower portion of said reservoir to operate on said second sealing section, the other of said fluids being selected into the group comprising the gas immiscible with said mineral oil and being housed in an upper portion of said reservoir to exert an additional compensation force.

By this way the advantage of having a sealing element with sealing sections against which oil will always act will be added to the above advantages, avoiding the drawbacks due to the use of the gas, i.e. of fluid with a lower molecular weight and thus more easily susceptible of leakage.

According to another aspect of the invention an apparatus comprising the above device is provided for lifting and/or transporting loads and/or persons.

Advantageous embodiments of the device and of the apparatus are provided according to the dependent claims.

### BRIEF DISCLOSURE OF THE DRAWINGS

Further features and advantages of the device and apparatus of the invention will become more apparent in light of the detailed description of some preferred but not exclusive embodiments thereof, shown only by way of non-limiting examples with the aid of the accompanying drawings in which:

FIG. 1 to 8 are schematic front views of an apparatus comprising the actuating device according alternative embodiments;

FIG. 9 is an enlarged and cross-sectional front view of a particular of an actuating device showing the sealing means;

FIG. 10 is a partial cross-section of some possible embodiments of a particular of the sealing means;

FIGS. 11 and 12 are schematic front views of an apparatus comprising an actuating device according two further embodiments;

FIG. 13 shows an apparatus according the invention comprising one of the above devices and defining a lift.

### BEST MODES OF CARRYING OUT THE INVENTION

With reference to the above cited figures, the device of the invention, globally referred with 1, may be applied to a fixed or movable apparatus for lifting and/or transport loads, only schematized in the figures and globally referred with 2, for assisting the same during the rising and/or lowering cycle of one or more loads.

The connection of the device 1 to the apparatus 2 may be either fixed or re-mountable, i.e. it can be excluded at any time, so as to use the apparatus 2 in a known manner.

In its more general version the actuating device 1 comprises a supporting frame 3 provided with support means 4 for an external load L, which may be represented by one or more objects and/or persons, guide means 5 associated with the frame 3 to guide the support means 4 along a predetermined direction, for example vertical, drive means 6 acting on the support means 4 to move them along the guide means 5 with a predetermined stroke c between a first and a second end position A, B.

For example, the first position A will be the lowest point of a vertical path, while the second position B will be the highest point that the support means 4 may reach, or may be an intermediate position that can be reached by the support means 4 after the predetermined stroke c and from which the same support means 4 may subsequently move towards a further higher position, for example by means of a further device according to the invention or also of other type.

The drive means 6 comprise a containment cylindrical jacket 7 defining a first working chamber 8 and housing thereinside a drive cylinder 9 adapted to exert a driving force F1 on the support means 4.

Furthermore, the drive means 6 comprise a compensation cylinder 10 located externally to the drive cylinder 9 and adapted to exert thereon a compensation force F2 sufficient to at least partially compensate the external load L.

Generally, the drive means 6 may integrate thereinside further devices, not shown, which may be connected directly or indirectly to the drive cylinder 9 and which will be selected into the group comprising pneumatic-, hydraulic-, fluid-dynamic-, gas-, electrical-, electromechanical-, for example with rack or worm screw, permanent magnet-type drive means or a combination thereof.

In turn, the compensation cylinder 10 may be preloaded with a predetermined force to exert on the support means 4 a compensation force F2, which preferably will be sufficient to keep the load L in an intermediate equilibrium position C between the two end positions A, B even when the drive cylinder 9 is not working.

The compensation cylinder 10 may be operatively connected to the support means 4 to exert the compensation force F2 both between the intermediate equilibrium position C and the upper end position B and between the intermediate equilibrium position C and the lower end position A.

In a preferred but not exclusive manner, the drive cylinder 9 may be sized in order to provide only the difference between the weight of the load L and the compensation force F2, to allow the minimization of their size, also allowing to minimize the size of the first supply means 11.

First supply means 11 are also provided for supplying in the first chamber 8 at least one pressurized fluid which is adapted to exert at least part of one of the above forces F1, F2.

In particular, the first supply means 11 will include a reservoir 12 containing predetermined amounts of two different fluids 13, 14 immiscible with each other and having respective menisci, respectively 15 and 16, in mutual contact, without interposition of elastic membranes or other separating walls.

A first 13 of these fluids will be adapted to be supplied in the first working chamber 8 to exert at least part of the said drive force F1 or of the above compensation force F2 on the drive cylinder 9, according to the needs and to the point of introduction of the fluid 13, as will appear more clearly from the detailed description of the various embodiments.

The second fluid 14 in the reservoir 12 will instead be adapted to transmit at least part of the compensation force F2 to the drive cylinder 9, and then to the support means 4, through the first fluid 13.

In FIG. 1 a balanced actuator device 1 is shown according to a first preferred but not exclusive embodiment, in which there is a drive actuator 9 defined by a piston, which may be either full or hollow but that is always not connected to the first supply means 11.

The drive cylinder 9 will be slidable in a sealed and guided manner inside the cylindrical jacket 7.

The first fluid 13 contained in the reservoir 12 will preferably be a mineral oil, while the second fluid 14 will be a fluid having a specific weight lower than the first fluid 12 to occupy the upper portion 12′ of the reservoir 12, with the first fluid 13 that will be positioned in the lower portion 12″.

Preferably, the second fluid 14 will be a gas, such as nitrogen, preferred for its safety features, even if it could be equally used other gas or also another liquid immiscible with the first fluid 13.

The driving force F1 may be exerted by the first fluid 13 drawn from the reservoir 12 through a first supply conduit 17 dimensioned so as to have a drawing mouth 18 located in the lower portion 12″ of the reservoir 12.

The first fluid 13, so defining the drive or pushing fluid, may be supplied into the first variable volume chamber 8 through the first supplying means 11, which for this purpose may include a motorized pump 19 selected in function of the flow rate to be drawn, of the pressures to be achieved and of the type of fluid.

By contrast the gas 14 located in the upper portion 12′ of the reservoir 12 will define the sole compensation fluid.

The gas 14 will be contained in the reservoir 12 without possibility of leakage to exert a compensation force F2 upon the variation of the pressure exerted by the drive cylinder 9 on the oil 13 contained in the first variable volume chamber 8.

According to a variant, not shown, the first supplying means 11 will be not provided with the pump 19 and the drive cylinder 9 will be operated through alternative mechanical, electromechanical and/or hydraulic systems, while both fluids 13, 14 in the reservoir 12 will define compensation fluids, with the first fluid 13 that will be supplied into the first chamber 8 through the conduit 17 only upon the pressure variation due to the volume variation of the first chamber 8 produced by the sliding of the drive cylinder 9 in the cylindrical jacket 7.

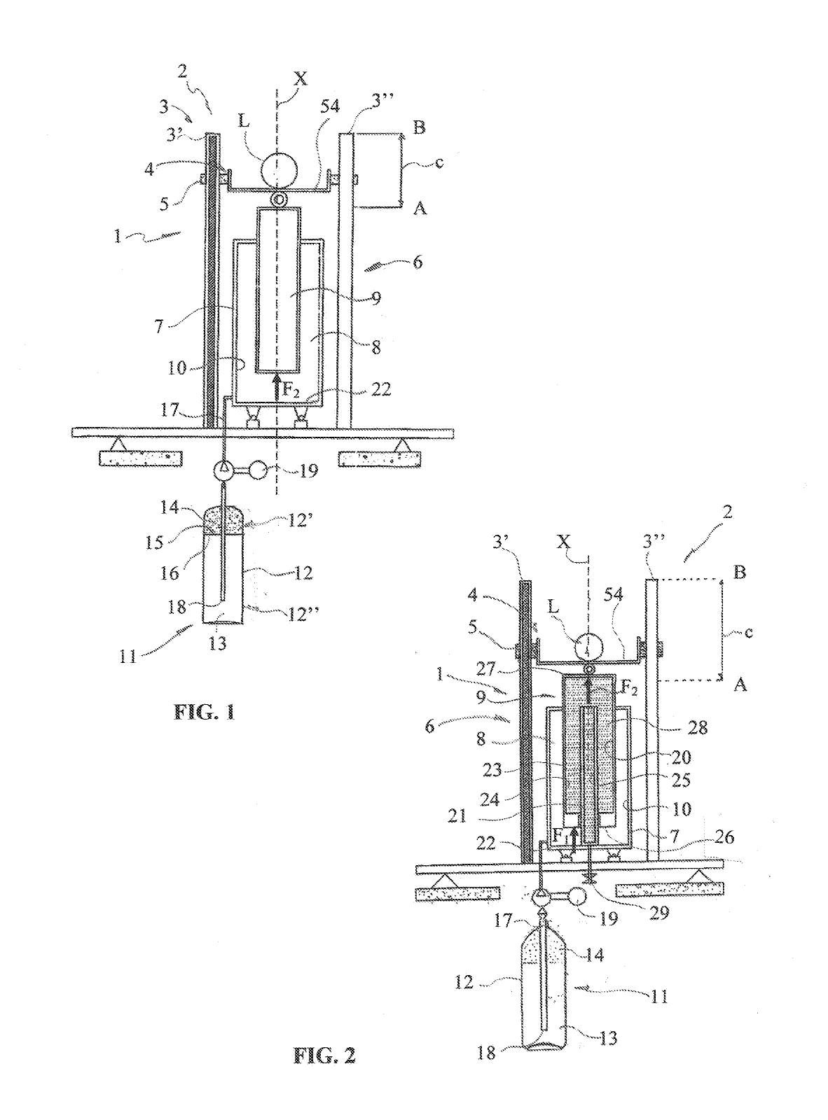

FIG. 2 shows a further embodiment of a balanced actuating device 1 in which the drive cylinder 9 is internally hollow to define thereinside a second variable volume chamber 20.

In this case, the drive cylinder 9 comprises a rod 21 fixed with respect to the support means 4, for example integral with the bottom wall 22 of the containment jacket 7, and a pushing element 23, sliding on the rod 21.

The latter will be internally hollow and in fluidic communication with the cavity 24 of the pushing element 23, so that the rod 21 will be at least partially inserted into the cavity 24 of the pushing element 23 to guide the same along the stroke c in a slidable and tight manner.

The cavity 25 of the guide rod 21 will be in fluidic communication with the cavity 24 of the pushing element 23 to allow the second chamber 20 to be supplied with a fluid.

The second variable volume chamber 20 will be so defined by the cavity 24 of the pushing element 23 and by the cavity 25 of the guide rod 21.

The pushing element 23 will be slidably and tightly inserted in the containment jacket 7 with its lower end 26 facing the bottom wall 22 thereof and the upper end 27 directly or indirectly connected to the support means 4 of the load L.

The pushing element 23 will slide along a longitudinal drive direction X under the pushing F1 of the first fluid 13 supplied from the reservoir 12 by the first supplying means 11 in the first chamber 8.

The second chamber 20 may instead be supplied with a third fluid 28, which in this case is preferably a gas, such as nitrogen, with the interposition of first valve means 29 which may be closed once a predetermined working pressure is established inside the second chamber 20.

By this way the compensation force F2 will be determined by the force exerted by the fluid contained in the second chamber 20 and the additional force exerted by the gas 14 in the reservoir 20.

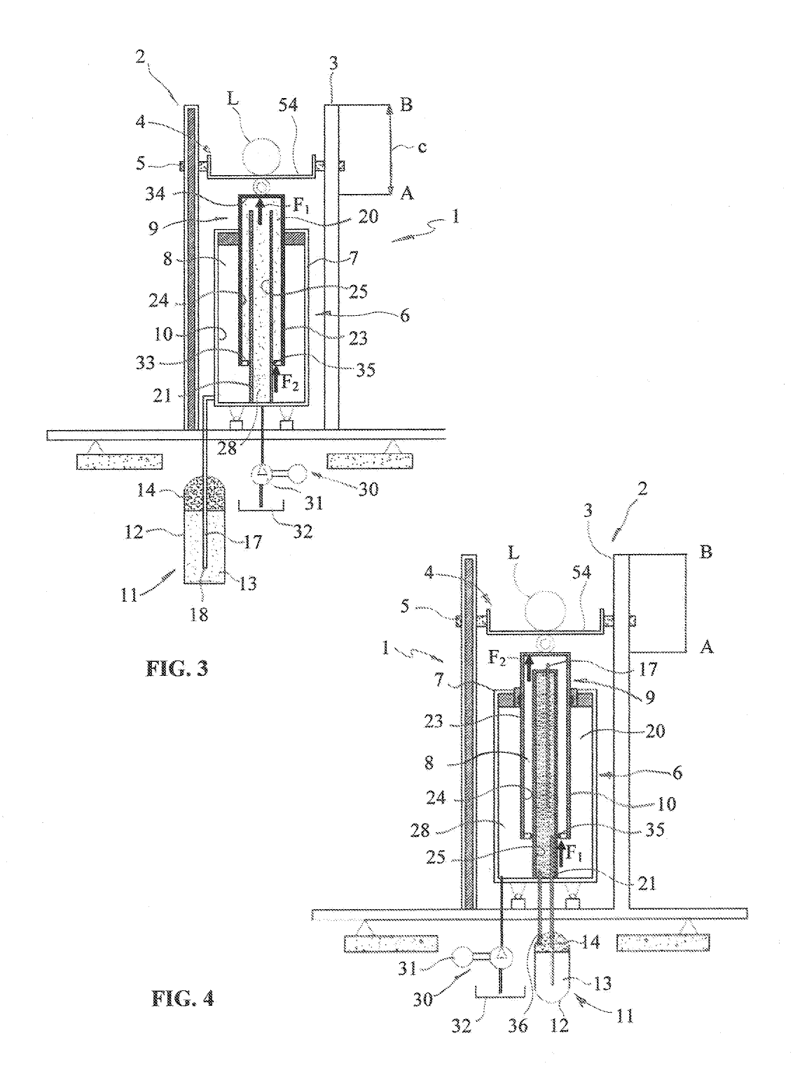

FIG. 3 shows a further embodiment of a balanced actuator device 1 that differs from that of FIG. 2 in that the second variable volume chamber 20 housed inside the drive cylinder 9 and defined by the cavity 24 of the pushing element 23 and by the cavity 25 of the fixed hollow rod 21 is connected to second power supply means 30 adapted to supply in the second chamber 20 the pressurized third fluid 28 that this time will be however adapted to transmit the driving force F1 to the pushing element 23.

The third fluid 28 will be any fluid, either liquid or gas, but preferably will be a mineral oil and the second supplying means 30 will comprise a suitably selected motorized pump 31 adapted to draw the third fluid 28 from a specific container 32 to send it inside the hollow rod 21.

In this manner, supplying the second variable volume chamber 20 with a predetermined amount of oil under pressure will get the raising of the support means 4 due to the fact that the fluid 28 thereinside will act with equal pressure on the two inner end faces 33, 34 of the pushing element 23 which, however, will have different sections due to the presence of the rod 21, with a resultant directed upwards which will produce the pushing F1.

Therefore, the containment jacket 7 will define the external jacket of the compensation cylinder 10, while the drive cylinder 9 will be at least partially contained in the compensation cylinder 10, so that the two cylinders 9, 10 will have development axes coincident with each other, allowing the reduction of the overall dimensions of the drive means 6 and making possible the application of the device 1 also in preinstalled apparatuses.

Therefore, the drive cylinder 9 and the compensation cylinder 10 will operate directly on the same pushing element 23 which will operate along a longitudinal movement axis of the load substantially parallel to the axes of the cylinders and that can be suitably parallel or coincident with the drive and moving direction X of the load L.

The two variable volume chambers 8, 20 enclosed by the two cylinders, respectively 10 and 9, will be hermetically insulted by suitable sealing means 35, described in more detail below in some preferred but not exclusive embodiments, adapted to prevent leakage of the fluids 13, 28 between the two chambers 8, 20.

FIG. 4 shows a further embodiment of the device 1, wherein the drive cylinder 9 comprises a hollow fixed rod 21 and a pushing element 23, hollow too and sealingly slidable on the rod 21.

However, in this case the cavity 25 of the rod 21 is upperly closed and not communicating with the cavity 24 of the thrust element 23, with this latter that will define the first variable volume chamber 8, also enclosed in the cylindrical jacket 7.

The reservoir 12 containing the two immiscible fluids 13, 14, for example oil in the lower portion 12″ and gas in the upper portion 12′, may be adapted to supply the cavity 24 of the pushing element 23 through the first supply conduit 17 sized to draw fluid always from the same lower portion 12″.

Suitably, the first conduit 17 may pass through the rod 21 and will project from the upper end thereof to be not affected by the movements of the pushing element 23.

A second conduit 36 will put into communication the upper portion 12′ of the reservoir 12, containing the gas, with the cavity 25 of the fixed rod 21.

The second variable volume chamber 20 will be also enclosed in the containment jacket 7 and supplied with the third fluid 28, through the second supplying means 30, to exert the driving force F1 on the pushing element 23.

The fluids 13, 14 contained in the reservoir 12, as well as in the cavities 24, 25, will exert the compensation force F2.

Since both chambers 8, 20 will preferably be supplied with a fluid 13, 28 selected into the group comprising mineral oils, the gas will never operate on the sealing means 35 interposed between the two chambers 8, 20, in such a manner to increase the reliability of the device 1, since the gas 14 will be retained in the reservoir 12 from the oil 13 and will be hermetically sealed in the rod 21 without leakage possibility.

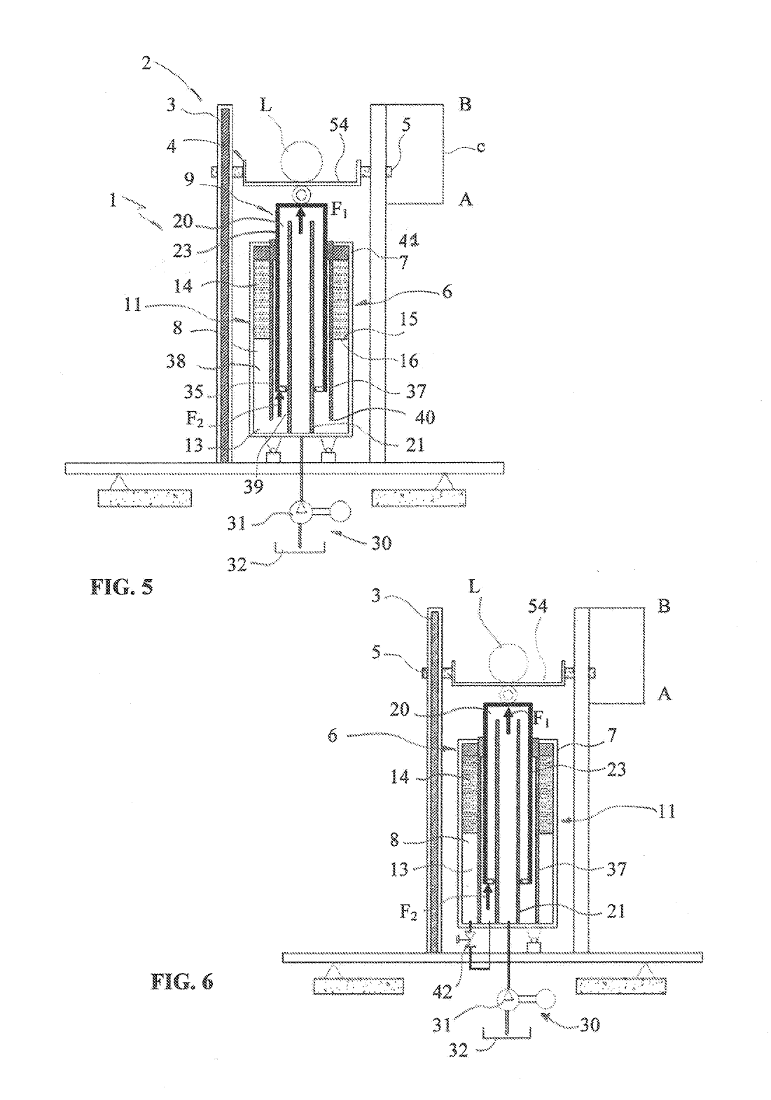

FIG. 5 shows an embodiment of the balanced actuating device 1 that differs from those described above primarily because the reservoir 12 containing the two amounts of immiscible fluids 13, 14 is contained or integrated into the containment jacket 7. Consequently, the first variable volume chamber 8 will define the reservoir 12.

Even in this case one of the fluid 14 will be a gas placed in the upper portion of the first chamber 8, while the other fluid 13 will be an oil placed in the lower portion to operate on the lower end of the pushing element 23 and on the sealing means 35 interposed between the two variable volume chambers 8, 20, avoiding that the gas 14 could be placed into contact with the same sealing means 35.

The drive cylinder 9 will be substantially of the same type as shown in FIG. 3, with the sealing means 35 which may be arranged at the lower end 26 of the pushing element 23, as shown, or at any other section, for example close to the upper opening of the rod 21, without any particular limitation.

A cylindrical tubular septum 37 will also be placed inside the cylindrical jacket 7 which septum divides the chamber 8 in a first outer tubular portion 38 with a fixed volume and an inner tubular portion 39 of variable volume coaxial with each other.

The septum 37 will have a side wall with an open lower end edge 40 spaced apart from the bottom wall 22 of the jacket 7 to keep the two tubular portions 38, 39 in mutual fluidic contact.

The object of the upper end 41 of the septum 37 is to guide the pushing element 23 and insulate the gas 14 from the outside without gaskets that may be subjected to gas leakage.

FIG. 6 shows a variant of FIG. 5, wherein the tubular septum 37 extends up to the bottom wall 22 to physically separate the two tubular portions 38, 39 of the first chamber 8, which will be selectively placed in fluid communication with each other through second valve means 42 of the normally open or normally closed type.

The second valve means 42 may be suitably closed, or open, to exclude the compensation cylinder 10 during maintenance or when it is required for safety reasons.

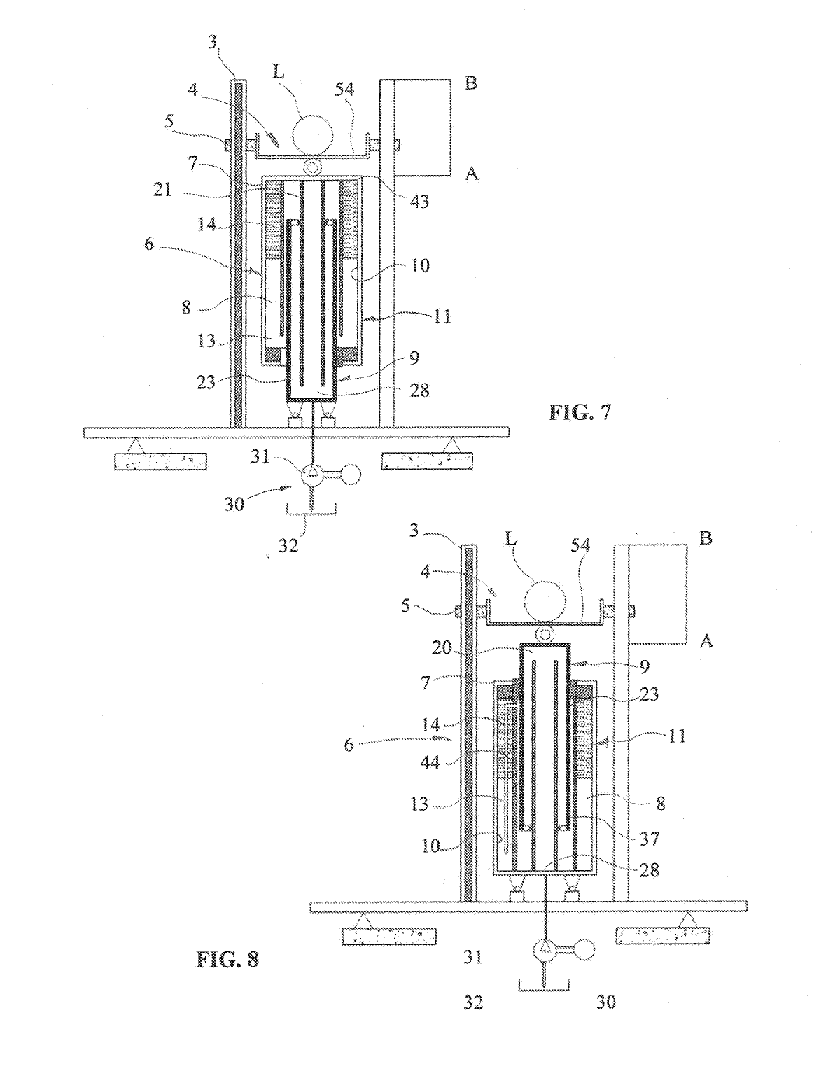

FIG. 7 shows a further variant of the device of FIG. 5, wherein the drive cylinder 9 has a configuration inverted with respect to the previous configuration, in particular rotated by 180° and with the rod 21 fixed to the upper wall 43 of the cylindrical jacket 7.

FIG. 8 shows a device 1 similar to that of FIG. 6 wherein, however, the second valve means 42 for excluding the compensation fluid are not provided, which second valve means being however similarly adapted to be provided, and wherein the inner tubular portion 39 of the first chamber 8 is connected to a collector 44 adapted to receive and/or supply the oil 13 upon the sliding of the pushing element 23 and to its greater or lesser penetration into the cylindrical jacket 7.

All the above embodiments have in common the advantage of always operating with at least two pressurized fluids, one of which will preferably be a gas, i.e. a particularly elastic fluid suitable to exert a compensation force, contained into the device 1 always in conditions of maximum safety and without the possibility of leakage, as will never operate directly on a seal, allowing a device thus made to perform a high number of cycles in autonomy.

Generally, the sealing means 35 include a sealing element 45 having a first sealing section 46 operating towards the first chamber 8 and a second sealing section 47 operating toward the second chamber 20.

Suitably, the two sealing sections 8, 20 will be adapted to support pressures of the respective fluids differentiated with each other.

As matter of fact, during use while on one hand it will be possible to establish a fixed pressure for the compensation fluid, in function of the percentage of load to balance, on the other hand the pressure of the drive fluid will vary according to the magnitude of the load L to be moved and of the greater or lesser penetration of the drive cylinder 9 inside the containment jacket 7, and then in function of the instantaneous volume of the specific chamber.

In this way different pressures will act on the two sealing sections 46, 47 which make inadequate traditional type sealings, such as O-ring or the like.

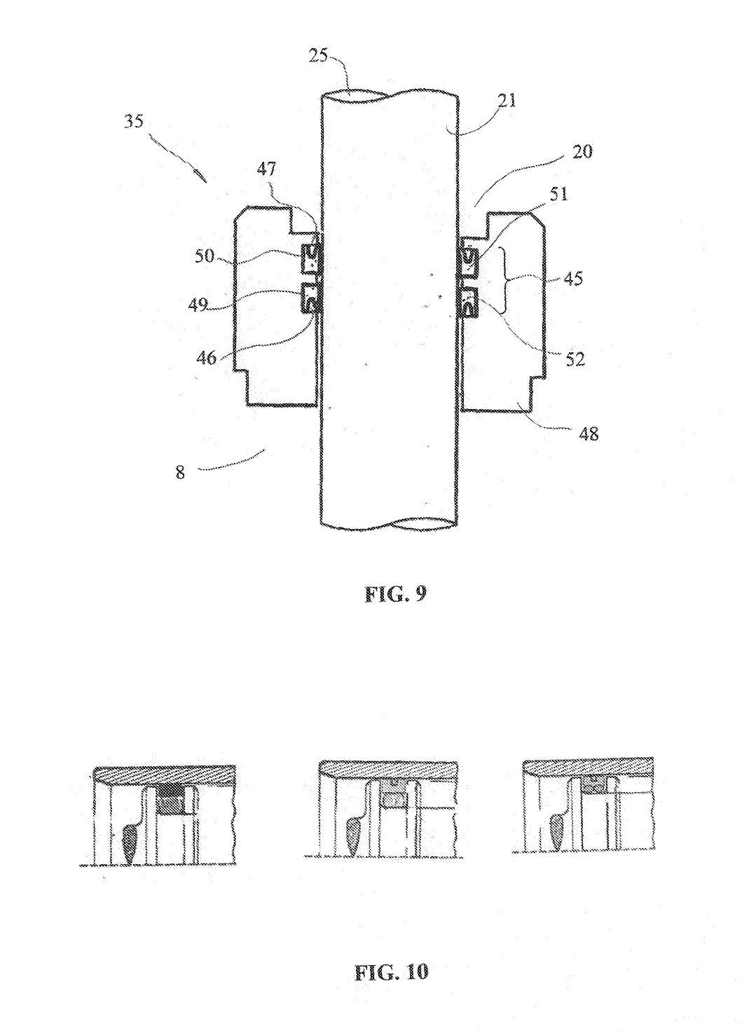

FIG. 9 shows an enlarged detail of a balanced actuator device 1 to highlight a possible configuration of the sealing means 35.

In particular, it could be noted that the sealing means 35 will comprise a sealing block 48 associated with at least one of the drive cylinder 9 and the compensation cylinder 10, for example fixed with the pushing element 23 to slide on the rod 21, and provided with a pair of housings 49, 50 for respective sealing sections 46, 47.

According to a preferred but not exclusive embodiment, the sealing element 45 may include or be defined by a first and a second gasket 51, 52 opposing each other and defining respectively the first and the second sealing section 46, 47.

Each gasket 51, 52 will be so designed to operate unidirectionally with a direction opposite to that of the other gasket to always guarantee the hermetic sealing from the side of the respective chamber 8, 20 and avoid fluids exchanges therebetween.

In a purely example way, the gaskets 51, 52 may be lip gaskets or the like housed in respective housings 49, 50 in mutually mirroring positions with respect to a middle plane orthogonal to the respective operative directions.

However, the sealing element 45 may also be of the unitary type but capable of working in a different manner on the two sealing sections 46, 47 in function of the different pressures acting on each of them.

For example, composite seals of NP, NPS, NPWJ, NPR, NPRG, NPQ1, NPQ2 and similar type, commonly available on the market, could be used or they may still be spring energized seals, wherein each sealing section 46, 47 is associated with an elastic pushing element, not shown, adapted to constantly maintain it in pressure in the respective operative direction.

Some possible embodiments of the sealing element are shown in the cross-sections of FIG. 10.

Advantageously, the sealing means 35, so designed, may be also used in actuator devices of known type and not necessarily provided with the reservoir 12 containing the two fluids 13, 14 in mutual contact with each other, for example in the balanced actuating devices disclosed in the above cited European patent EP2152623.

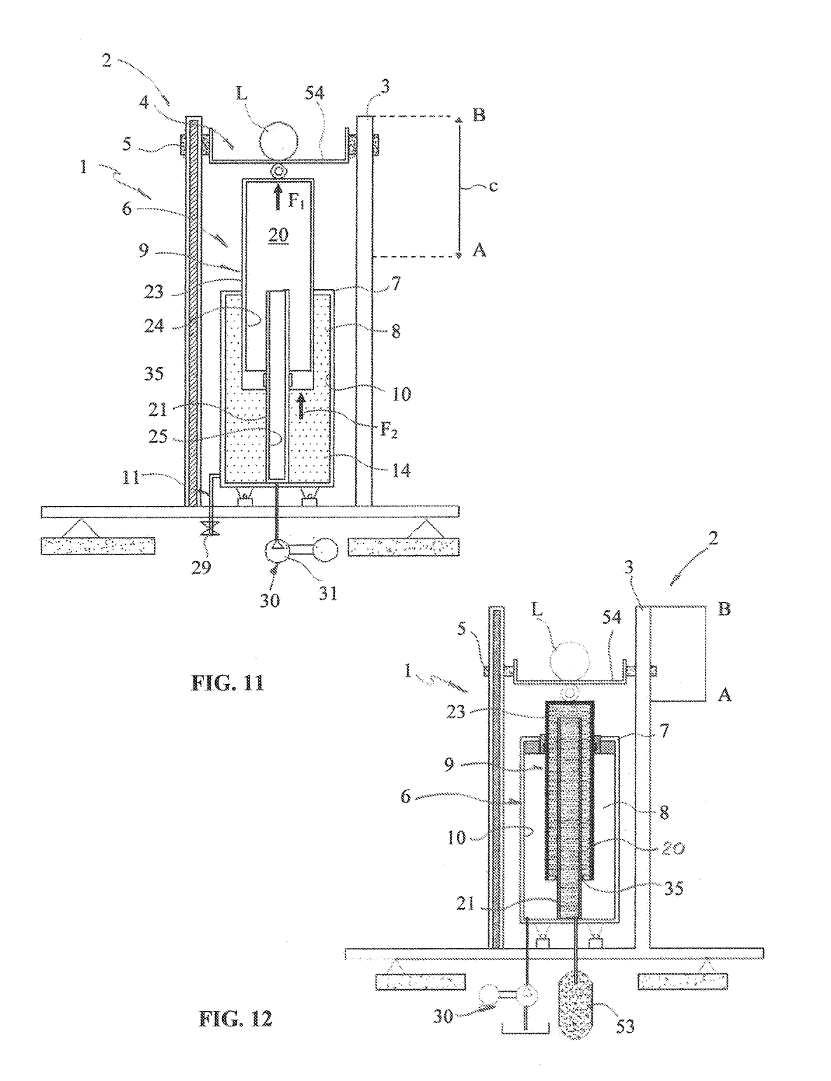

FIGS. 11 and 12 show two possible embodiments for a balanced actuating device 1 provided with the above sealing means 35.

In particular, in FIG. 11 an actuating device 1 is shown having a drive cylinder 9 and a compensation cylinder 10 with respective axes parallel to each other and to the operation direction X of the guide means 5.

The compensation cylinder 10 may be defined by the outer containment jacket 7, which will house the first variable volume chamber 8 adapted to be filled with a predetermined volume of a first working fluid, such as nitrogen or another gas having appropriate compressibility properties, to exert on the drive cylinder 9, and through this on the support means 4, the compensation force F2.

The drive actuator 9 will be of the type disclosed in FIG. 3, and will define thereinside a second variable volume chamber 20 supplied with oil by the second supply means 30.

However, the type of fluids is not limiting for the present invention as it will be possible to use any type of fluid in each of the chambers 8, 20, also according to an inverted embodiment with respect to that shown.

The two variable-volume chambers 8, 20 will be appropriately insulated by means of the sealing element 45 that may be arranged in the sliding area of the pushing element 23 on the rod 21, as shown, or at the interaction area between the pushing element 23 and the outer jacket 7, or, further, at any interface area between the two chambers 8, 20, so as to prevent fluid exchanges between the chambers 8, 20.

The second chamber 20 may be connected to a reservoir of pressurized fluid, not shown, or other similar supply device, through the second supplying means 30 which will include pumping means 31 of known type and suitably selected depending on the fluid and on the pressures to be reached, without particular limitations, with the possible interposition of valve means, not shown as being of known type.

In turn, the first chamber 8 may be connected in a fixed or removable manner to one or more reservoirs containing pressurized gas, not shown in the figures, and that may also be of the removable type, through appropriate first valve means 29 designed to be a closed once the fluid in the first chamber 8 has reached the predetermined balancing pressure.

The configuration of FIG. 12 differs from that of FIG. 11 essentially for the fact that the first chamber 8 is supplied with oil through the supply means 30 to exert the drive force F1, while the second chamber 20 is connected to a reservoir 53 containing the compensation fluid, preferably gas.

In this case, the drive force F1 will be applied directly to the outer lower end of the pushing element 23.

In a specific variant of the drive cylinder 9, not shown in these figures but implementable within any of the devices disclosed above, in particular in the embodiments having an external reservoir 12, the drive cylinder 9 may be of the telescopic type, for example of the synchronous type with more extensions, with a plurality of sections vertically arranged and possibly adapted to be supplied in a selective manner through a valve or solenoid valve, to bring the load L at respective intermediate positions corresponding to respective predetermined values of the compensation force F2 exerted by the compensation cylinder 10.

The use of telescopic cylinders will avoid, in particular in the case of lifts or platforms, the need for relevant building works, especially in renovation, such as excavation works that would otherwise be necessary to house cylinders with bulkier minimum dimensions.

In yet another embodiment, also not shown, the first chamber 8, when acting as compensation chamber, may be supplied through one or more external reservoirs, with the aim of storing therein the potential energy produced during the lowering of the support means 4 for totally or partially reusing it by acting on the single reservoirs when there is the full load to be raised, or when the stroke c to be run is higher and/or a greater pressure is needed in the compensation cylinder 10, which pressure being lacking with respect to the lower position as a result of Boyle's law.

In this case sensors and/or pressure switches will be provided for sending signals to an electromechanical or electronic control to manage the solenoid valves of the accumulators.

The support means 4 for the load L may include a platform 54, a cabin or other means susceptible of supporting the external load L.

Preferably, the guide means 5 may comprise substantially rectilinear guides 55 associated to the frame 3, which in turn may be constituted by one or more pairs of vertical and parallel or inclined rails 3′, 3″, on which a slit, carriage or arch 56 solidal to the platform or cabin 54 may be slidably mounted.

The slit or carriage or arch or cabin 56 may be moved by the actuator device 1 also through systems with pulleys and ropes for size operation.

In all the shown embodiments, the device 1 can be completed through the provision of additional seals or auxiliary elements, such as oil scrapers or the like, according to methods known to a person skilled in the art and therefore not described in more detail.

The materials used for the different parts of the device 1 may be selected among the materials commonly used in the technical field, in function of the used fluids and their operating pressures, as well as the loads to be moved and any other operational requirement, in theory metals, polymers or composites, also of the natural type, being adapted to be used.

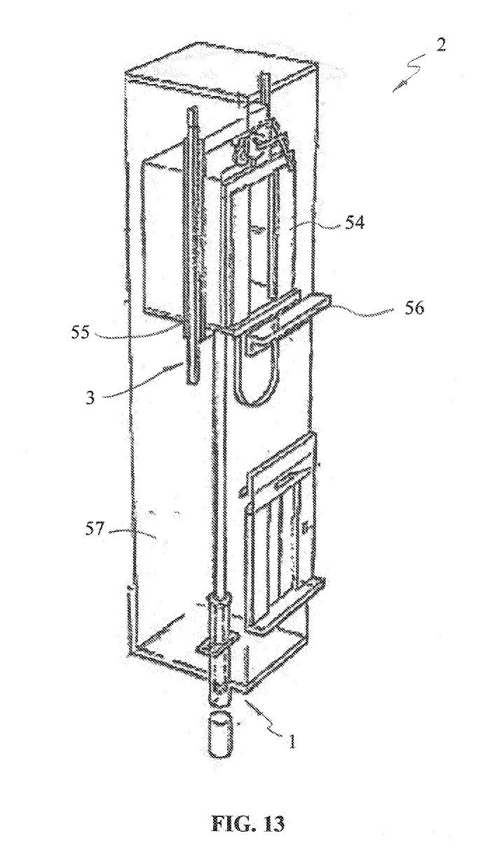

FIG. 13 shows a particular configuration of a lifting apparatus 2 comprising the device 1 of the invention, wherein the apparatus 2 defines a typical elevator comprising a supporting frame 3 having a support for loads and/or persons, for example an elevator car 54, and in whose compartment 57 a balanced actuating device 1 may be housed which device being adapted to operate on the support 54 to move it along the frame 3.

The application of the device 1 according to the invention to an elevator system 2 will be particularly advantageous as it will be required, with the same speed and load, lower power compared to the hydraulic systems or traditional rope electric systems, other than for having lower power consumption.

Moreover, even if the powers will be the same of the hydraulic systems with counterweight, the so designed device 1 is less complex to be managed and more simple to install.

Finally, it will be not necessary to increase the used power in case of replacement of existing rope elevator with an hydraulic solution.

The apparatus 2 may also be a lifter mounted on wheels, useful for carrying an operator located within an upper cage associated with the device 1 peripherally to a platform defining the support means 4.

In particular, for platforms it may be advantageous to use a device 1 of the type shown in FIGS. 1 to 4, i.e. with an external reservoir 12, since in this case there are no particular problems of encumbrance.

Instead, the solution with the reservoir 12 integrated into the containment jacket 7 will be preferable for elevators and other lifting systems in which it is even more necessary to reduce the overall dimensions.

The device and the apparatus above disclosed are susceptible of numerous modifications and variations. All the details may be replaced with other technically equivalent elements, and the materials may be different depending on the needs, without departing from the scope of the invention.

Although the device and the apparatus have been disclosed with particular reference to the annexed figures, reference numbers in the description and in the claims are used to improve the intelligence of the invention and do not constitute any limitation to the scope of the claimed protection.

The invention claimed is:

1. A balanced actuating device for lift and/or transport apparatuses, comprising:
a supporting frame (3) having a support (4) for an external load (L);
a guide (5) associated with said frame (3) for guiding said support (4) along a predetermined drive direction (X); and
a drive (6) operating on said support (4) for moving said support along said guide (5) with a predetermined stroke (c) between a first and a second end position (A, B), wherein said drive (6) comprises:
a cylindrical jacket (7) enclosing a first working chamber (8) and housing thereinside a drive cylinder (9) configured to exert a drive force (F1) on said support (4);
a compensation cylinder (10) placed externally to said drive cylinder (9) and configured to exert thereon a compensation force (F2) sufficient to at least partially balance the external load (L); and
a first supply station (11) of said first chamber (8) providing at least one pressurized fluid adapted to exert at least part of one of said drive or compensation forces (F1, F2);
wherein said first supply station (11) comprises a reservoir (12) containing predetermined amounts of two different fluids (13, 14) immiscible with each other and having respective menisci (15, 16) into reciprocal contact, a first one (13) of said fluids being adapted to be supplied into said first working chamber (8), the other one (14) of said fluids being adapted to transmit to said drive cylinder (9), through said first fluid (13), at least part of the compensation force (F2).

2. The balanced actuating device as claimed in claim 1, wherein said second fluid (14) has specific weight lower than said first fluid (13), thereby occupying an upper portion (12′) of said reservoir (12).

3. The balanced actuating device as claimed in claim 2, wherein said first supply station (11) comprises a first drawing conduit (17) configured to draw said first fluid (13) from said reservoir (12) and to send said first fluid into said first chamber (8).

4. The balanced actuating device as claimed in claim 3, wherein said first fluid (13) is a mineral oil and said second fluid (14) is a gas.

5. The balanced actuating device as claimed in claim 1, wherein said drive cylinder (9) is internally hollow for housing thereinside a second variable volume working chamber (20).

6. The balanced actuating device as claimed in claim 5, wherein said first supply station (11) is adapted to supply said second variable volume working chamber (20) with a third pressurized fluid (28) configured to exert on said drive cylinder (9) at least part of said drive force (F1).

7. The balanced actuating device as claimed in claim 6, wherein said third fluid (28) comprises a mineral oil.

8. The balanced actuating device as claimed in claim 5, wherein said drive cylinder (9) comprises a guide rod (21) fixed with respect of said support (4) and a pushing element (23) slidable on said rod (21) and internally hollow for defining at least part of said second variable volume working chamber (20).

9. The balanced actuating device as claimed in claim 8, wherein said guide rod (21) is internally hollow and in fluidic communication with a cavity (24) of said pushing element (23) to define therewith said second variable volume working chamber (20).

10. The balanced actuating device as claimed in claim 1, wherein said drive cylinder (9) is telescopic with a maximum extension sufficient to totally cover said predetermined stroke (c).

11. The balanced actuating device as claimed in claim 5, wherein said first and said second chamber (8, 20) are fluidically insulated with from each other by a hermetic seal (35) and are respectively connected with the first and a second supply station (11, 30) of the corresponding fluids.

12. The balanced actuating device as claimed in claim 11, wherein said hermetic seal (35) comprises at least one sealing element (45) placed between said first chamber (8) and said second variable volume working chamber (20) for their reciprocal insulation and for avoiding leakage of fluids contained therein.

13. The balanced actuating device as claimed in claim 12, wherein said sealing element (45) has a first sealing section (46) operating toward said first chamber (8) and a second sealing section (47) operating toward said second variable volume working chamber (20), said first and second sealing sections (46, 47) being configured to contrast pressures of the respective fluids acting thereon.

14. The balanced actuating device as claimed in claim 13, wherein said hermetic seal (35) comprises a sealing block (48) associated with at least one of said drive cylinder (9) or said compensation cylinder (10) and provided with a pair of housings (49, 50) for said first and second sealing sections (46, 47).

15. The balanced actuating device as claimed in claim 14, wherein said sealing element (45) comprises a first and a second gasket (51, 52) opposite to each other and defining respectively said first and said second sealing sections (46, 47), each of said first and second gaskets (51, 52) being designed to unidirectionally operate with a direction opposite to the direction of the other gasket.

16. The balanced actuating device as claimed in claim 15, wherein said first and second gaskets (51, 52) comprise a lip sealing gasket.

17. The balanced actuating device as claimed in claim 14, wherein each of said first and second sealing sections (47, 48) is associated with an elastic biasing element adapted to constantly keep said first and second sealing sections pressurized along a corresponding operating direction.

18. The balanced actuating device as claimed in claim 13, wherein said reservoir (12) is enclosed inside said jacket (7) to define said compensation cylinder (10), one of said fluids (13) contained into said reservoir (12) being a mineral oil housed in a lower portion (12″) of said reservoir (12) and operating against said second sealing section (47), the other one of said fluids (14) being a gas not miscible with said mineral oil and being placed in an upper portion (12′) of said reservoir (12) for exerting at least part of said compensation force (F2).

19. An apparatus for lifting and/or transporting loads and/or persons, comprising:
a supporting frame (3) having a support (4) for loads and persons and defining thereinside an housing or compartment (57) for at least one balanced actuating device (1) adapted to operate on said support (4) to move said along said frame (3), wherein said balanced actuating device (1) comprises:
a guide (5) associated with said frame (3) for guiding said support (4) along a predetermined drive direction (X); and
a drive (6) operating on said support (4) for moving said support along said guide (5) with a predetermined stroke (c) between a first and a second end position (A, B), wherein said drive (6) comprises:
a cylindrical jacket (7) enclosing a first working chamber (8) and housing thereinside a drive cylinder (9) configured to exert a drive force (F1) on said support (4);
a compensation cylinder (10) placed externally to said drive cylinder (9) and configured to exert thereon a compensation force (F2) sufficient to at least partially balance an external load (L); and
a first supply station (11) of said first chamber (8) providing at least one pressurized fluid adapted to exert at least part of one of said drive or compensation forces (F1, F2);
wherein said first supply station (11) comprises a reservoir (12) containing predetermined amounts of two different fluids (13, 14) immiscible with each other and having respective menisci (15, 16) into reciprocal contact, a first one (13) of said fluids being adapted to be supplied into said first working chamber (8), the other one (14) of said fluids being adapted to transmit to said drive cylinder (9), through said first fluid (13), at least part of the compensation force (F2).

20. The apparatus as claimed in claim 19, wherein said support (4) comprises an elevator car.
